(19) United States
(12) Patent Application Publication
(10) Pub. No.: US 2013/0218719 A1
(43) Pub. Date: Aug. 22, 2013

(54) Online Barter System

(71) Applicant: Yair Jackoby, Reno, NV (US)

(72) Inventor: Yair Jackoby, Reno, NV (US)

(21) Appl. No.: 13/400,767

(22) Filed: Feb. 21, 2012

(51) Int. Cl. G06Q 30/06

(52) U.S. Cl. 705/26.35; 705/26.1

(57) ABSTRACT

An online barter system for facilitating the exchange of services of equivalent value includes a computer connected to a computer network and having a processor and memory. Programming causes the processor to receive barter offer data from a system subscriber/donor over the network. A monetary value and a corresponding quantity of barter credits are associated with the submitted barter offer. The system includes programming for receiving barter selection data from another subscriber, the request including a request to redeem a respective barter offer using the subscriber's barter credits. The system determines if the requester has sufficient barter credits to redeem the requester barter offer. The system facilitates performance of a redeemed barter service and the recipient may offer online feedback. If the feedback is positive, the donor's credits are increased and the recipient's credits are decreased. The system allows for negative feedback to be challenged by a respective donor.

### BACKGROUND OF THE INVENTION

This invention relates to information systems and, more particularly to an online business method configured to enable subscribing users to exchange services without the exchange of actual payment. The online barter system enables users to submit offers to provide services to other users and to redeem submitted offers so long as a respective redeeming user has sufficient barter credits in his associated account to exchange for performance of a desired service.

Professional and consumer services, such as accounting, handyman, automotive repair services, and the like are typically offered to consumers on an hourly billing basis or as a fixed rate for a particular service. Many consumers are unable to pay for such valuable services at the time the service is rendered but may have the ability to pay by performing a different service of generally equal value. For instance, a first party may be able to provide an accounting service for a second party and the second party may be able to provide a roofing service for the first party. Exchanging services as a mode of payment is known as bartering and has been used for many years as a means of commerce.

A limitation with a traditional barter transaction is that the two parties may not be willing or able to provide a particular service that is desirable to the other party. In such a case, no transaction is made and both parties are left unsatisfied. In the above example, for instance, the party willing to provide an accounting service may not desire a roofing service in return or the party providing roofing services may not desire accounting services.

Therefore, it would be desirable to have an online barter system that enables many users to submit/offer a service they are willing to provide and to enable other users to search for desired services. In this way, a user is able to obtain a desired service that has been offered and posted on the system and to offer services to others who may need or desire them. Further, it would desirable to have an online barter system that monetizes submitted services such that services may be offered and selected using “barter credits.” In addition, it would be desirable to have an online barter system in which a user is able to offer feedback for a service that has been selected and performed.

### SUMMARY OF THE INVENTION

An online barter system for facilitating the exchange of services of generally equivalent value includes a computer connected to a computer network and having a processor and memory. Programming in memory causes the processor to receive barter offer data from a system subscriber/donor over the computer network. Submitted barter service offers are stored in memory and displayed as a barter pool. A monetary value and a corresponding quantity of barter credits may be associated with the submitted barter offer and stored in memory. The system also includes programming for receiving barter selection data from another subscriber, the request including a request to redeem a respective barter offer using the requesting subscriber's barter credits. The system determines if the requester has sufficient barter credits to redeem the requester barter offer.

The system facilitates performance of a redeemed barter service and the recipient may offer online feedback. If the feedback is positive, the donor's credits are increased and the recipient's credits are decreased. The system allows for negative feedback to be challenged by a respective submitter of the redeemed service. The submitting subscriber's credits and requesting subscriber's credits remain frozen while a dispute is being resolved.

Therefore, a general object of this invention is to provide an online barter system that enables users to exchange services of generally equivalent value without an actual exchange of monetary funds.

Another object of this invention is to provide an online barter system, as aforesaid, in which an authorized user of the system may submit an offer to provide a service to another user who may redeem/select it.

Still another object of this invention is to provide an online barter system, as aforesaid, that associates so-called barter credits with an account associated with a submitted barter service, the credits corresponding to an estimated monetary value of the service offer.

Yet another object of this invention is to provide an online barter system, as aforesaid, in which an authorized user may select a previously submitted service so long as the user has sufficient barter credits to redeem it.

A further object of this invention is to provide an online barter system, as aforesaid, an online barter system, as aforesaid, that facilitates performance of a selected barter service and the adjustment of barter credits of both the donating subscriber and the redeeming subscriber.

A still further object of this invention is to provide an online barter system, as aforesaid, that enables the redeemer of a barter service to provide online feedback regarding the sufficiency of the performed service.

Another object of this invention is to provide an online barter system, as aforesaid, that enables a submitter of a barter service to challenge any negative feedback that may be provided regarding the service he submitted or the sufficiency of the performance thereof.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a flowchart illustrating the logic of an online barter system according to a preferred embodiment of the present invention; and

FIG. 2 is another flowchart further illustrating the logic of an online barter system.

### DESCRIPTION OF THE PREFERRED EMBODIMENT

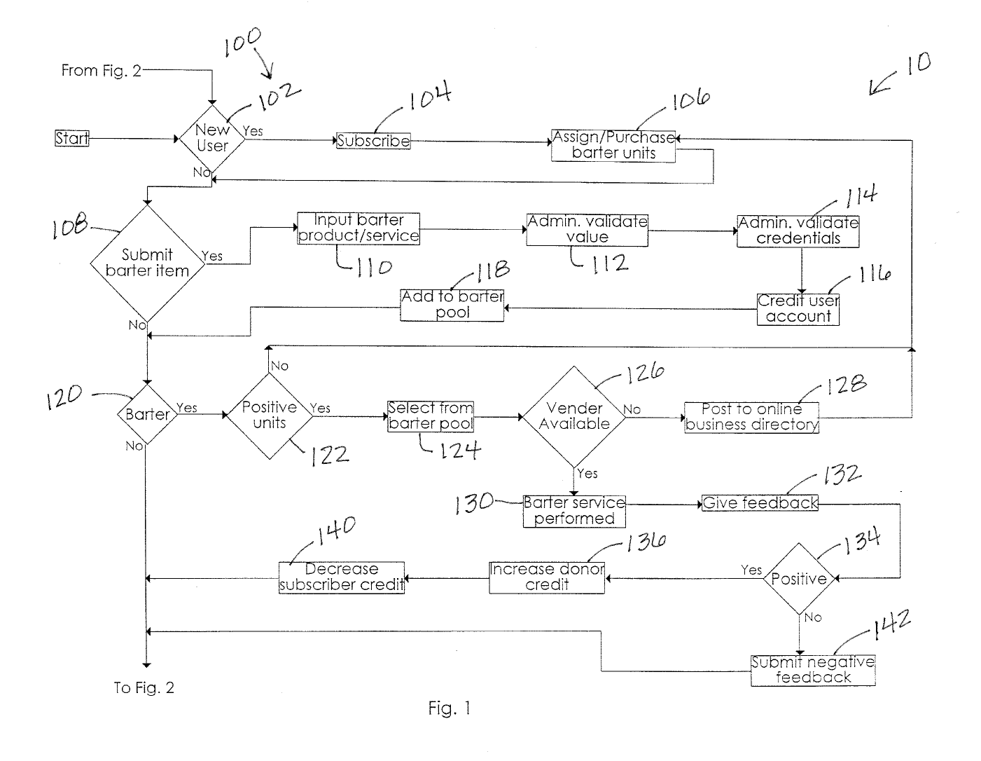

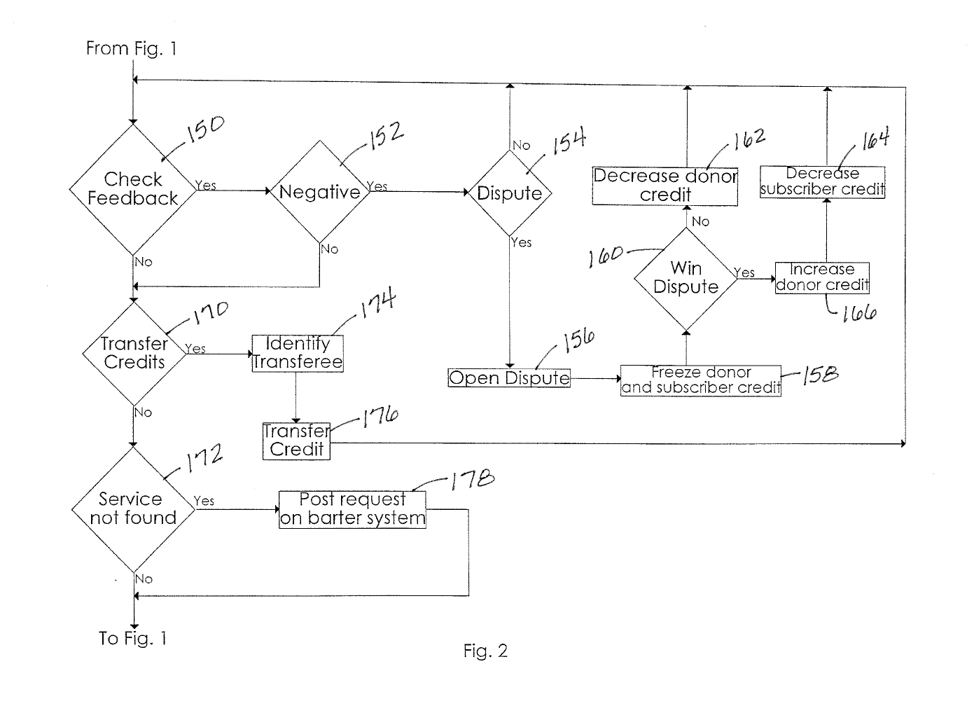

An online bartering system according to a preferred embodiment of the present invention will now be described in detail with reference to FIGS. 1 and 2 of the accompanying drawings.

The online barter system 10 includes a computer (not shown) connected to a computer network (not shown) such as the internet. The computer includes a memory and a processor electrically connected to the memory. The system 10 includes programming stored in the memory that when executed by the processor causes the system 10 to operate the online barter system 10 as further described below.

The online barter system 10 is implemented by a process 100 according to the computer programming executed by the processor as described below. An exemplary process 100 of the online barter system 10 is illustrated in the flowcharts in FIGS. 1 and 2. At step 102 of the process 100, the processor first determines if a user attempting to access the barter system computer is an authorized user. Preferably, the system 10 is only accessible by subscribers or users that have previously created an account on the system 10. If a potential user is determined to be an existing user/subscriber, then the process 100 proceeds to step 108. Otherwise, the process 100 proceeds to step 104 which initiates a subscription procedure and proceeds to step 106. At step 106, a new user is assigned a predetermined number of initial “barter credits” and enabled to purchase additional credits if desired. Barter credits correspond to a monetary value associated with a submitted offer of a service to be utilized in a barter transaction as will be described in more detail later. It is understood that a new subscriber/user to the system 10 may be given an account having data structures that will be associated with that user's information, barter credits, submitted barter service offer, and the like. All user accounts will be stored in memory for recall by the computer as transactions relative thereto are made, as will be described in more detail below. After collecting initial information so as to form a new user account, the processor proceeds to step 108.

At step 108, the processor determines if a user accessing the barter system computer desires to submit a barter item, (i.e. to submit a barter service offer) and, if so, proceeds to step 110. Otherwise, the process 100 proceeds to step 120. At step 110, the processor receives input from the user over the computer network relative to barter offer data. Specifically, the processor receives data regarding the user's offer to provide a service, for example a number of hours of accounting services.

Upon receipt of the barter data, the process 100 proceeds to step 112 at which an administrator or his delegate determines, assigns, or validates an estimated monetary value of the service being offered. It is understood that a user submitting a barter service may also be referred to as a donor, a submitter, a user who has submitted a service offer, or the like. Preferably, the monetary value associated with a submitted barter service offer is stored in memory and associated with the account of the user who submitted the service offer. It is understood, however, that the quantity of barter credits corresponding to the determined monetary value of a submitted service is not added to the associated user's account until the submitted service is selected, performed, and in receipt of positive feedback as will be described in more detail below.

The process 100 then proceeds to step 112 at which the administrator may review and validate the credentials of the submitting user so as to verify that the user is capable or at least likely to be capable of performing the service when redeemed or, alternatively, to adjust the monetary value of the service offer in light of the submitter's credentials. A quantity of barter credits corresponding to the monetary value of the submitted service offer will be added to the submitting user's account when another user has redeemed/selected service offer, as will be described later. The process 100 may then continue to step 116 at which the barter credits corresponding to a submitted service may be associated with a user's account for later use after the submitted service is performed. Finally, the submitted barter offer may be submitted to a “barter pool” at step 118 which is a data structure that includes all barter service offers available for redemption by authorized subscribers/users as will be described in more detail below. It is understood that the barter pool may be visually displayed to all authorized users upon demand. The process 100 then proceeds to step 120.

At step 120, the processor executes programming to determine if an authorized user desires to “barter” or, in other words, to request, select, or redeem an offered service from the barter pool. If the processor determines that a user desires to enter a barter request, the process 100 proceeds to step 122 at which the process 100 determines if the user has sufficient barter credits on his account to make a request. More particularly, the processor may access the user's account and determine if the user has sufficient barter credits to redeem a service offer. If there are sufficient credits, the process 100 may proceed to step 124 at which the requesting user may select a service—selection of a service may also be referred to as “redeeming” a service and the service offer itself may be referred to as a redeemed respective service offer. If the user's account does not have enough barter credits, the process 100 returns to step 106 at which the user is given opportunity to purchase more barter credits. It is understood that the order of the process steps with respect to redeeming a service offer may be executed in another order. For instance, the process 100 may enable a requesting user to select a desired service at step 124 before verifying that the user has enough barter credits to redeem the desired service offer at step 122. After a service offer has been redeemed, the process 100 proceeds to step 126.

At step 126, the processor determines if a vendor is available to perform the selected service. In some instances, the user that submitted the offered service will be available and is preferred to provide the best service. For instance, the user may be certified public accountant who has submitted an offer to provide 5 hours of free accounting. When another user selects that service, the submitting user may be contacted to provide the offered service. If, however, the submitting user is not available or it is not feasible for the submitting user to provide the service, then the processor, via programming, will determine at step 126 that no vendor is currently available. For example, an offered service may be for 5 hours of carpentry. If that service, however, is redeemed by a user several hundred miles from the submitting user, then the processor will determine at step 126 that a vendor is unavailable.

If the processor determines at step 126 that a vendor is unavailable, then the need for a vendor who can render the service may be posted to an online directory at step 128 and control is returned to step 106. Preferably, a vendor who can provide the needed service will be offered an opportunity to subscribe to the system 10 or perhaps be given a free selection of an equivalent service from the barter pool.

If, however, a vendor is available at step 126, such as if the submitter of the service offer is available to perform the service, then the process 100 proceeds to step 130. At step 130, the process 100 may facilitate performance of the service, for example, by notifying the submitting user regarding who to contact to render the promised service. After performance of the service, the process 100 proceeds to step 132. At step 132, the requesting/redeeming user is given the opportunity to provide feedback regarding the service that was just recently performed. Obviously, this feedback may be positive or negative depending on the experience, diligence, or expertise of the vendor (which may be the user who submitted the service offer.

At step 134, the processor may determine if the feedback is positive and, if so, the process proceeds to step 136. Otherwise, the process 100 proceeds to step 137. At step 136, the processor will increase the submitting user's barter credits by an amount corresponding to the previously determined value of the respective service offer. The process 100 then proceeds to step 138 at which the processor will decrease the redeeming user's barter credits by an amount corresponding to the previously determined value of the redeemed respective service offer. It is understood that the processor may electronically access the respective accounts of the respective users stored in memory in order to identify the number of barter credits associated with a previously determined value of the service and to increase and decrease the respective barter credits. At step 137, the user for whom the selected service was performed may submit negative feedback. After either of step 140 or 142, the process 100 proceeds to step 150.

At step 150, the processor under programming control determines if an authorized user desires to check feedback about that user's submitted service offer(s). If the processor determines that a user desires to check feedback, the process 100 proceeds to step 152; otherwise, the process continues to step 170. At step 152, the process 100 again determines if the feedback is negative. If the processor determines that the feedback is not negative, then the process 100 continues to step 170; otherwise, the determination is that the feedback is negative and the process continues to step 154. At step 154, the processor determines if the user wishes to dispute the negative feedback. In other words, the processor determines if the user wishes to open a dispute resolution procedure. If a dispute resolution procedure is not desired, then control is returned to step 150, i.e. a menu. However, if a dispute resolution procedure 100 is desired then the process proceeds to step 156 where a dispute resolution procedure is initiated.

After a dispute resolution procedure is initiated at step 156, the process 100 continues to step 158 where the processor may access the respective accounts of the user who submitted the redeemed respective service offer and of the user who redeemed/selected the redeemed respective service offer. In this way, the barter credits of both users can be “frozen” and will remain unchanged until resolution of the matter. It is understood that a dispute may be resolved by a system administrator or committee. The process 100 may then continue to step 160. At step 160, the processor determines if the user who challenged the negative feedback won the dispute and, if so, the process 100 continues to step 166;

otherwise, the process 100 continues to step 162 where the barter credits in the account of the submitter of the redeemed service offer are reduced or, alternatively, left the same. This is the situation where the provision of the redeemed service idea was inferior and generated negative feedback. By contrast, if the dispute was successful (proving that the negative feedback was unjustified), then the barter credits in an account associated with the submitter of the redeemed service offer is increased at step 166 and the barter credits in an account associated with the receiver of the redeemed service offer is decreased. As explained above, the adjustment of barter credits is in an amount corresponding to the previously determined monetary value of the service having been selected and performed. Thereafter, the process 100 returns to step 150.

At step 170, the processor under programming control determines if an authorized user desires to transfer some or all of his barter credits to another subscriber. If so, then the process 100 continues to step 174; otherwise, the process 100 continues to step 172. At step 174, the identity of another subscriber to receive a portion of a user's barter credits is determined. The process 100 then continues to step 176 where the processor actively transfers a specific amount of barter credits from a requestor's account into a specific transferee's account. The process 100 is then returned to the menu at step 150.

At step 172, the processor under programming control determines if an authorized user desires to indicate that a service that he desires to barter for is not currently found on the in the barter pool of the system 10. If the desired service is not found, then the process 100 proceeds to step 178 where the desired service may be posted on the system 10. In other, the other users are put on notice of the desired service and urged to submit that particular service offer Then the process 100 returns to step 102 (i.e. a system menu of function choices).

It is understood that steps 102, 108, 120, 150, 170, and 172 may be implemented as a menu displayed on a user interface enabling a user to select a desired programming routine. It is also understood that the present system may be adapted to barter for goods in a manner substantially similar to the method described herein for services.

In use, users having a desire to offer services as payment for receiving other services may subscribe to the system by accessing it online and entering personal information. The system may or may not include an initial or periodic subscription fee and may charge other fees for use. A subscriber is an authorized user and may selectively submit a service offer and/or select a service offer. A submitted service offer may be evaluated by an administrator and assigned a monetary value. A new user may be allotted a predetermined number of barter credits or may have the option to purchase initial or additional barter credits, barter credits being required to “redeem” a service from the pool of submitted barter service offers.

If a user has sufficient barter credits with which to obtain a selected service offer, the service offer will be performed for the selecting user, either by the user who submitted the offer or by another suitable vendor. Once the service is performed, the user who received the service has the opportunity to provide positive or negative feedback. Negative feedback may be disputed. If the feedback is positive or if the user who submitted the service offer is successful challenging negative feedback, then the barter credits of the user who submitted the service offer may be increased while the barter credits of the recipient may be decreased. On the other hand, if the feedback is negative and a challenge thereof is unsuccessful, then the barter credits of the user who submitted the service offer are decreased (or at least not increased) and the recipient's barter credits are not decreased. In other words, if a selected and performed service offer is inferior, the submitter of the service is not rewarded and the recipient is not “charged” the anticipated quantity of barter credits.

Process 100 illustrate a plurality of steps that may be considered a method of utilizing a computer and computer network to perform on online business.

It is understood that while certain forms of this invention have been illustrated and described, it is not limited thereto except insofar as such limitations are included in the following claims and allowable functional equivalents thereof.

1. An online barter system for facilitating the exchange of services of generally equivalent value, comprising:
a computer electrically connected to a computer network, said computer having a memory configured to store programming and data structures;
a processor electrically connected to said computer and to said memory configured to execute said programming;
programming in said memory that, when executed by said processor, causes said processor to:
receive a barter offer submitted by a submitting user over said computer network, said barter offer including an offer to perform a service;
associate a monetary value with said received barter offer;
associate a predetermined quantity of barter credits to an account associated with said submitting user;
store said received barter offer, said associated monetary value, and said associated barter credits in said memory;
receive a barter selection from a redeeming user over said computer network, said barter selection including a request to redeem a respective barter offer;
determine if said redeeming user associated with said barter selection has sufficient barter credits to redeem said respective barter offer; and
facilitate performance of said redeemed respective barter offer if said redeeming user is determined to have sufficient barter credits to redeem said respective barter offer.

2. The online barter system as in claim 1, further comprising programming in said memory that, when executed by said processor, causes said processor to:
determine whether a user attempting to access said computer over said computer network is an authorized user; and
allow said user to access said computer if said user is determined to be an authorized user.

3. The online barter system as in claim 1, wherein said programming to associate a monetary value with said received barter offer includes requesting a system administrator to evaluate the credentials of said submitting user.

4. The online barter system as in claim 2, further comprising programming in said memory that, when executed by said processor, causes said processor to:
receive new subscriber data submitted by a user attempting to access said computer over said computer network previously determined to be an unauthorized user; and
assign a predetermined quantity of barter credits to an account associated with said new subscriber.

5. The online barter system as in claim 1, further comprising programming in said memory that, when executed by said processor, causes said processor to:
determine if a vendor is available to perform said redeemed respective barter service; and
post said redeemed respective barter service to an online business directory if said vendor is not available to perform said redeemed respective barter service.

6. The online barter system as in claim 1, further comprising programming in said memory that, when executed by said processor, causes said processor to:
receive feedback from a user for whom said redeemed respective barter service has been performed;
determine if said feedback is positive and, if so:
increase said quantity of barter credits in a respective account associated with a respective submitting user who submitted said redeemed respective barter service by an amount corresponding to a respective monetary value of said redeemed respective barter service; and
decrease said quantity of barter credits in a respective account associated with a respective redeeming user who redeemed said redeemed respective barter service by an amount corresponding to a respective monetary value of said redeemed respective barter service.

7. The online barter system as in claim 6, wherein if said feedback is determined to be positive, then said programming to receive feedback causes said quantity of barter credits associated with said account of said respective submitting user who submitted said redeemed respective barter service and said account of said redeeming user who redeemed said redeemed respective barter service by the same quantity corresponding to said associated monetary value corresponding to said redeemed respective barter service.

8. The online barter system as in claim 7, further comprising programming in said memory that, when executed by said processor, causes said processor to receive a request by a user to review feedback regarding a respective barter offer submitted by said user, if any.

9. The online barter system as in claim 8, further comprising programming that, if said feedback associated with said user requesting feedback is negative, causes said processor to determine if said user requesting feedback desires to open a dispute resolution procedure to challenge said negative feedback and, if so, causes said processor to freeze said barter credits of said respective submitting user who submitted said redeemed respective barter service until said dispute is resolved.

10. The online barter system as in claim 9, further comprising programming that causes said processor to determine if said dispute is resolved in favor of said user challenging said negative feedback and, if so, causes said processor to increase the barter credits of said user challenging said negative feedback and to decrease said barter credits of said user that redeemed said redeemed respective barter service.

11. The online barter system as in claim 1, further comprising programming in said memory that, when executed by said processor, causes said processor to receive a user request to transfer a quantity of said user's barter credits to another user and, upon identification of said another user, to make said requested transfer.

12. The online barter system as in claim 1, further comprising programming in said memory that, when executed by said processor, causes said processor to receive a user request for other users to submit a specific barter service offer.

13. A method implemented on a computer connected to a computer network that facilitates the exchange of services of generally equivalent value, comprising the steps of:
receiving a barter offer submitted by a submitting user over the computer network, said barter offer including an offer to perform a service;
associating a monetary value with said received barter offer;
associating a predetermined quantity of barter credits to an account associated with said submitting user;
storing said received barter offer, said associated monetary value, and said associated barter credits in the computer;
receiving a barter selection from a redeeming user over said computer network, said barter selection including a request to redeem a respective barter offer;
determining if said redeeming user associated with said barter selection has sufficient barter credits to redeem said respective barter offer; and
facilitating performance of said redeemed respective barter offer if said redeeming user is determined to have sufficient barter credits to redeem said respective barter offer.

14. The method as in claim 13, wherein said step of associating a monetary value with said received barter offer includes evaluating the credentials of said submitting user.

15. The method as in claim 13, further comprising:
receiving new subscriber data submitted by a user attempting to access the computer over the computer network; and
assigning a predetermined quantity of barter credits to an account associated with said new subscriber.

16. The method as in claim 13, further comprising:
determine if a vendor is available to perform said redeemed respective barter service; and
posting said redeemed respective barter service to an online business directory if said vendor is not available to perform said redeemed respective barter service.

17. The method as in claim 13, further comprising:
receiving feedback from a user for whom said redeemed respective barter service has been performed;
determining if said feedback is positive and, if so:
increasing said quantity of barter credits in a respective account associated with a respective submitting user who submitted said redeemed respective barter service by an amount corresponding to a respective monetary value of said redeemed respective barter service; and
decreasing said quantity of barter credits in a respective account associated with a respective redeeming user who redeemed said redeemed respective barter service by an amount corresponding to a respective monetary value of said redeemed respective barter service.

18. The method as in claim 17, further comprising:
receiving a request by a user to review feedback regarding a respective barter offer submitted by said user, if any; and
if said feedback associated with said user requesting feedback is negative, determining if said user requesting feedback desires to open a dispute resolution procedure to challenge said negative feedback and, if so, causing said processor to freeze said barter credits of said respective submitting user who submitted said redeemed respective barter service until said dispute is resolved.

19. The method as in claim 18, further comprising the step of causing said processor to determine if said dispute is resolved in favor of said user challenging said negative feedback and, if so, causes said processor to increase the barter credits of said user challenging said negative feedback and to decrease said barter credits of said user that redeemed said redeemed respective barter service.

20. The method as in claim 13, further comprising the step of causing said processor to receive a user request to transfer a quantity of said user's barter credits to another user and, upon identification of said another user, to make said requested transfer.
